(19) United States
(12) Patent Application Publication
(10) Pub. No.: US 2008/0077442 A1
(43) Pub. Date: Mar. 27, 2008

(54) Networking of digital health information

(76) Inventors: Anuthep Benja-Athon, New York, NY (US); Theda Benja-Athon, Port Washington, NY (US)

Correspondence Address: ANUTHEP BENJA-ATHON, M.D.;Pain Management, Acupuncture Physical Therapy, 210 E 36th St., New York, NY, 10016, US

(21) Appl. No.: 11/523,945

(22) Filed: Sep. 21, 2006

(51) Int. Cl. G06F 19/00

(52) U.S. Cl. 705/3

(57) ABSTRACT

A method of using contents in the digital medical records to procure information comprising explanations and descriptions on diagnoses, symptoms, signs, syndromes, diseases and illnesses and to procure and to use associated words, terms, phrases, sentences based on the practice of medicine to further obtain information.

### FIELD OF INVENTION

A method of using contents of digital medical records to optimize health-care.

### BACKGROUND OF THE INVENTION

Despite the talks and ubiquitous publications—a part of the proposed strategy to solve the current and festering American health-care crisis—on transforming American patients and employers and corporations into educated and wise health-care consumers and buyers in the current health-care system, the reality is there is neither prior art, means nor know-how to either allow or facilitate said parties and America or the world for that matter to achieve said wish.

The present invention is yet another component of an innovative and unique national and international health-care system being formed and supported by several pending patent applications of this physician applicant and his co-applicants.

### OBJECTIVES OF THE INVENTION

The present invention is a know-how and the most effective and realistic means for achieving said objectives.

The present invention provides each and every patient—and in many circumstances, physicians—with the most efficient and instant means and method of obtaining, understanding and retaining information on and relating to his or her diseases, illnesses, disorders, diagnoses, differential diagnoses, symptoms, signs, aggregates of symptoms and signs, syndromes, diseases, illnesses and disease and illness processes and medications and related.

As a result, the present invention provides each and every patient—and in many circumstances, physicians—with the most efficient management of his or her diseases, illnesses, disorders, diagnoses, symptoms, signs, aggregates of symptoms and signs, syndromes, diseases, illnesses and disease and illness processes and medications and all related.

Consequently, the benevolent benefits of the present invention for humanity are hugely immense in terms of perpetually improving billions of people's quality of life and standard of living, reducing human suffering and saving of thousands, if not millions, of lives each year.

### SUMMARY OF THE INVENTION

There is neither prior art nor effective know-how for transforming American patients, employers and corporations into educated and wise health-care consumers and buyers in the current health-care system.

The present invention provides a means and method of linking words, terms, phrases and sentences describing diagnoses, symptoms, signs, aggregates of symptoms and signs, syndromes, diseases, illnesses, disease and illness processes, medications in the digital health, health-care and medical records of individuals display by a means for displaying said health, health-care and medical records to digital information comprising explanations, information, details, illustrations, images and depictions on or relate to said diagnoses, symptoms, signs, aggregates of symptoms and signs, syndromes, diseases, illnesses and disease and illness processes and medications and related wherein said words, terms, phrases, sentences are used by individuals and computers or servers to find and procure digital information comprising explanations, information, details, illustrations, images and depictions on or relate to said diagnoses, symptoms, signs, aggregates of symptoms and signs, syndromes, diseases, illnesses and disease and illness processes and medications and related adaptable to be displayed for viewing by said means for displaying and to further procure related, associated or pertinent words, terms, phrases, sentences, descriptions, details, illustrations, images and depictions based on physicians' uses and applications of words, terms, phrases, sentences, images, illustrations and depictions on or relating to diagnoses, symptoms, signs, aggregates of symptoms and signs, syndromes, diseases, illnesses, disease and illness processes and medications adaptable to be displayed and be used by said individuals and wherein words, terms, phrases, sentences, illustrations, images and depictions embedded or present in said descriptions, explanations, information, details, explanations, illustrations, images and depictions further are used and enable said individuals and computers or servers to further procure digital information comprising pertinent or related explanations, details, descriptions, information, details, explanations, illustrations, images and depictions on or relate to said diagnoses, symptoms, signs, aggregates of symptoms and signs, syndromes, diseases, illnesses and disease and illness processes adaptable to be displayed for viewing by said means for displaying.

### DESCRIPTION OF THE PREFERRED EMBODIMENTS

The innovative and unique system for generating digital health, health-care and medical data or records by physicians and patients are taught by the pending patent applications of the present physician applicant and his co-applicants. Therefore, the present invention teaches the uses and applications of the digital contents of said physicians- and patients-generated health, health-care and medical data or records by physicians and patients to achieve the objectives of the present invention.

At least two pending patent applications of this physician applicant and his co-applicants taught a system wherein said words, terms, phrases and sentences in said data or records of patients generated by physicians can be computer-automatically tagged, mark-up or enabled—see the underlined words, terms and phrases in examples infra—to be used for linking to, finding and procuring descriptions, explanations, clarifications, information, details, illustrations, images and depictions on, relate or pertain to diseases, illnesses, disorders, diagnoses, differential diagnoses, symptoms, signs, aggregates of symptoms and signs, syndromes, diseases, illnesses and disease and illness processes and medications involving and affecting said individuals which are present in databases of computers and/or servers.

Thus, the present invention provides patients and physicians with a means and a method of obtaining descriptions, explanations, clarifications, information, details, illustrations, images and depictions on, relate or pertain to diseases, illnesses, disorders, diagnoses, differential diagnoses, symptoms, signs, aggregates of symptoms and signs, syndromes, diseases, illnesses and disease and illness processes and medications involving and affecting said patients and other people.

More precisely, the present invention provides patients and physicians with a means and a method of achieving said objectives through the use of words, terms, phrases and sentences describing diagnoses, symptoms, signs, aggregates of symptoms and signs, syndromes, diseases, illnesses, disease and illness processes, medications in the digital health, health-care and medical records of patients. Physicians authorized to access a patient's record or patients' records can achieve all objectives of the present invention. Therefore, patients can focus on the information on diagnoses, symptoms, signs, aggregates of symptoms and signs, syndromes, diseases, illnesses, disease and illness processes, medications affecting or involving them.

The present invention provides a method of procuring digital information comprising descriptions and explanations of diagnoses, symptoms, signs, aggregates of symptoms and signs, syndromes, diseases, illnesses and disease and illness processes and medications wherein words, terms, phrases and sentences describing diagnoses, symptoms, signs, aggregates of symptoms and signs, syndromes, diseases, illnesses and disease and illness processes and medications in said physicians- and patients-generated health, health-care and medical data or records display by a means for displaying said digital information, heath and medical records are used—computers/servers assisted—by said patients and physicians for procuring and displaying said digital information, illustrations, images and depictions.

In each and every said record, words, terms, phrases, sentences, illustrations, images, depictions and the like or any combination thereof according to the preferred embodiments of the present invention are set up in or programmed in the computers or servers to be related or linked to database or databases of data or information on health, health-care, medicine and surgery.

The present invention provides a method of linking words, terms, phrases and sentences describing diagnoses, symptoms, signs, aggregates of symptoms and signs, syndromes, diseases, illnesses, disease and illness processes, medications in the health, health-care and medical records of individuals display by a means for displaying said health, health-care and medical records wherein said words, terms, phrases, sentences or any combination thereof are used by patients to find and procure digital information on health, health-care, medicine, surgery and science comprising explanations, information, details, explanations, illustrations, images and depictions on, about or relate to said diagnoses, symptoms, signs, aggregates of symptoms and signs, syndromes, diseases, illnesses and disease and illness processes adaptable to be displayed for viewing by said means for displaying. See examples infra.

Thus, computer programs, software, programming languages and processes are applied by the present application to enable computers and/or servers to automatically mark-up, link or relate—see the underlined words, terms and phrases in examples infra—significant words, terms, phrases and sentences in said health, health-care and medical data or records to digital information comprising explanations, information, details, illustrations, images and depictions on or relate to said diagnoses, symptoms, signs, aggregates of symptoms and signs, syndromes, diseases, illnesses and disease and illness processes and medications and related to achieve the objectives of the present invention within the spirit and scope of the claims of the present invention.

Similarly, computer programs, software, programming languages and processes are applied by the present application to enable computers and/or servers to automatically mark-up or markup, tag, link or relate words, terms, phrases, sentences, illustrations, images, depictions embedded in digital information comprising explanations, information, details, illustrations, images and depictions on or relate to said diagnoses, symptoms, signs, aggregates of symptoms and signs, syndromes, diseases, illnesses and disease and illness processes and medications and related from database or databases to achieve the objectives of the present invention within the spirit and scope of the claims of the present invention.

Similarly, furthermore, computer programs, software, programming languages and processes are applied by the present application to enable computers and/or servers, patients and physicians to retrieve, query, modify, manipulate said information, records, data and databases to achieve the objectives of the present invention.

Another preferred embodiments of the present invention—albeit humanly tedious and less desirable than supra—is the applications of computer programs, software, programming languages and processes to enable physicians and patients to manually tag, mark-up or markup words, terms, phrases and sentences and to link or relate said words, terms, phrases and sentences to digital information comprising explanations, information, details, illustrations, images and depictions on or relate to said diagnoses, symptoms, signs, aggregates of symptoms and signs, syndromes, diseases, illnesses and disease and illness processes and medications and related from database or databases.

Similarly, furthermore, computer programs, software, programming languages and processes are applied by the present application to enable patients and physicians to retrieve, query, modify, manipulate—computers and/or servers assisted—said information, records, data and databases to achieve the objectives of the present invention.

Yet another preferred embodiment of the present invention is the applications of computer programs, software, programming languages and processes to allow patients and physicians to type words, terms, phrases, sentences or any combination thereof to search or find, query, retrieve and procure said digital information from database or databases.

Each word, term, phrase, sentence or any combination thereof and words, terms, phrases, sentences or any combination thereof is or are set up in or programmed in the computers or servers to search or find explanations, information, details, explanations, illustrations, images and depictions on, about or relate to said diagnoses, symptoms, signs, aggregates of symptoms and signs, syndromes, diseases, illnesses and disease and illness processes, medications and related information such as, but not limited to, pharmacology, indications, contraindications, side-effects, interactions and allergy. The search results are then displayed by said means for displaying means for displaying said health, health-care and medical records.

Therefore, said certain significant words, terms, phrases, sentences or any combination are enabled or capable by virtue of said set up and programs in the computers or servers to procure pertinent or related information from database or databases comprising health, health-care, medicine, surgery and science.

Said data, records, and information are displayed by a means for displaying said digital information, health and medical records and digital health information such as, but not limited to, computers, laptops, mobile, cellular or smart phones, equipment and devices and the like. Individual's said data or record comprises health and health-care data on said individual owner of said record and data comprising of words, terms, phrases and sentences generated by said individual, his or her physicians and also computers/servers managing and storing said data.

1. Thus, an individual who own and has access to and then manipulate his or her health or medical record display his or her said record on the screen or screens of said means for displaying. Then said individual can choose certain significant word, term, phrase, sentence or any combination thereof and words, terms, phrases, sentences or any combination thereof by pointing by the pointer or the like on the screen and selecting by clicking the computer mouse or the like a word, term, phrase, sentence or any combination thereof and words, terms, phrases, sentences or any combination thereof in his or her health or medical record. These significant word, term, phrase, sentence, words, terms, phrases, sentences or any combination thereof is or are enabled to procure or retrieve digital information relating to a word, a term, a phrase, a sentence, words, terms, phrases, sentences available from and store in databases comprising health, health-care, medical, surgical scientific data in the computers and/or servers.

First example, a representation of a portion of the digital data or medical record of a patient generated by physicians and said patient wherein words, terms, phrases are markup or tagged and linked according to the preferred embodiments supra and is displayed by said means for displaying as follows:
46 year old woman with past medical history of fibromyalgia, asthma, obesity, hypertension, left Bell's palsy, hypothyroidism, diabetes, heart attack, idiopathic thrombocytopenic purpura, gall bladder stone and low back spinal stenosis and past surgical history of splenectomy presents with low back pain, paresthesia allodynia, hyperalgesia, paresthesia, hyperesthesia, hyperpathia and right buttock pain.
MEDICATION ALLERGY: penicillin and cephalosporin
MEDICATIONS: synthroid vioxx lidocaine patch aspirin
PHYSICAL EXAMINATION:
   Vertebral Column: slumbosacral vertebrae are in midline
   Paraspinal Muscles, Palpation: moderate stiffness and tenderness and hypersensitivity in the area of LS area—see below.
   Gluteals: Moderate tenderness of the right GMXM and right posterior hamstrings trigger point points.
   Hips: Patrick's test, left—negative, right—negative
      Trochanteric bursa, left—negative, right—negative
   Neurology:
      Sensations to LT, PP, Vibration—normal
      Deep tendon reflex, bilateral quadriceps—0+
      Deep tendon reflex, right triceps surae—0+, left 0+
      Babinski's, bilateral—negative
ASSESSMENT AND PLAN: Right buttock and leg pain—neuropathic pain and stage 1 reflex sympathetic dystrophy (RSD).
TREATMENT: Medical acupuncture and trigger point injection.

An example of one of the preferred embodiments of the present invention, said patient clicks said tagged words describing a disease—Bell's palsy—the following representative description is procured and displayed:
Bell's palsy was reserved for describing idiopathic facial paralysis in which the cause of the facial paralysis was not known.
However, an earlier report suggested that there was an association between Bell's palsy and infections and chronic diseases. Currently, the results obtained from patients described herein positively show a causal relationship between the viral, bacterial and spirochetal infections, vascular cause and the compromise of the facial nerve leading to facial paralysis. Therefore, henceforth, Bell's palsy is synonymous with the compromise or compression of the facial nerve causing facial paralysis as a result of an inciting infection, vascular cause or a combination thereof.

An example of one of the preferred embodiments of the present invention, said patient clicks said tagged words supra—right buttock pain—the following representative description is procured and displayed:
Fibromyalgia has been afflicting humans since prehistoric time. It is an integral part of human's response to stress and strain, injuries, arthritis, degeneration and aging. Throughout time, different words, terms and descriptions have been used to describe fibromyalgia. For example, the acupuncture points depicted on a plastic mannequin and various descriptions assigned to these points are well-known ancient representation of fibromyalgia. However, regardless of time, languages and expressions, the tender trigger points on the body such as the shoulders and buttocks and the widespread and complex constellation of pain and disorders described herein are most common and constant, albeit of varying onsets, degrees and intensities, in humans.

2. Furthermore, said words, terms, phrases and sentences, illustrations, images, depictions able to procure and display related or associate word, term, phrase, sentence, words, terms, phrases, sentences explanations, details, descriptions, information, illustrations, images, depictions or any combination thereof which are displayed and serve to further procure and display pertinent or related explanations, details, descriptions, information, illustrations, images and depictions on, about or relate to said diagnoses, symptoms, signs, aggregates of symptoms and signs, syndromes, diseases, illnesses and disease and illness processes, medications and related.

For example, one of the preferred embodiments of the present invention, another result of clicking said tagged words describing said disease—Bell's palsy—the following representative related or associated words and terms describing related or associated diseases are procured and displayed to be used according to the method supra as represents by a brief presentation as follows:
The percentage of the 121 patients with chronic diseases prior to the onset of Bell's palsy was as follow:

| % OF PATIENTS | CHRONIC DISEASES |
|---|---|
| 10 | Diabetes mellitus |
| 8 | High blood pressure or hypertension |
| 4 | Arteriosclerosis |
| 2.5 | Leukemia or lymphoma |
| 2 | Chronic renal disease |
| 0.8 | Bone Paget's disease |
| 0.8 | Trigeminal neuralgia |
| 0.8 | Postpolio |
| 0.8 | Multiple sclerosis |
| 0.8 | Convulsive disorder |
| 0.8 | Rheumatoid arthritis |

(W. A. Hauser et al., 1971)
Conditions that appeared to predispose to paralysis of the facial or other cranial nerves were as follow:
   Diabetes mellitus
   High blood pressure or hypertension
   Artheriosclerosis
   Pregnancy

Thus, the present invention provides the displays and further uses of related or associate word, term, phrase, sentence, words, terms, phrases, sentences explanations, details, descriptions, information, illustrations, images, depictions or any combination thereof upon the uses of words, terms, phrases and sentences, illustrations, images, depictions according to the method supra.

3. Even furthermore, words, terms, phrases and sentences, illustrations, images, depictions are embedded or present in said procured and displayed explanations, details, descriptions, information, illustrations, images and depictions as illustrated supra which are displayed and serve to further procure and display pertinent or related explanations, details, descriptions, information, illustrations, images and depictions on, about or relate to said diagnoses, symptoms, signs, aggregates of symptoms and signs, syndromes, diseases, illnesses and disease and illness processes, medications and related.

Another example of one of the preferred embodiments of the present invention, a word, term, phrase, sentence, words, terms, phrases, sentences or any combination thereof procure and display a sample description comprising of the following description:
Fibromyalgia, fibrositis, fibromyositis, trigger point, myofascial pain syndrome, cervicobrachial pain syndrome—to name several—and related disorders belong to an extremely common constellation of nerve, muscular and skeletal diseases and disorders afflicting humans. They share the same origin and path leading to complex and diverse symptoms, manifestations and illnesses. To facilitate understanding, therefore, the term fibromyalgia hereupon serves to represent the constellation.

Said patient clicks said embedded and underlined word, in this example—fibromyalgia—to further procure and display a sample description comprising of the following description:
Fibromyalgia has been afflicting humans since prehistoric time. It is an integral part of human's response to stress and strain, injuries, arthritis, degeneration and aging. Throughout time, different words, terms and descriptions have been used to describe fibromyalgia. For example, the acupuncture points depicted on a plastic mannequin and various descriptions assigned to these points are well-known ancient representation of fibromyalgia. However, regardless of time, languages and expressions, the tender trigger points on the body such as the shoulders and buttocks and the widespread and complex constellation of pain and disorders described herein are most common and constant, albeit of varying onsets, degrees and intensities, in humans.
Heretofore, fibromyalgia was labeled “idiopathic”, “unknown cause or etiology” or “unknown pathogenesis or mechanism”. As a result, the diagnosis was haphazard and effective treatment was not administered.

By clicking said phrase—cervicobrachial pain syndrome—a detailed description or explanation and perhaps accompanying illustrations and images are procured and displayed.

Similarly, by clicking said term—plastic mannequin—procure and display a detailed description or explanation, and illustration and images of a human showing trigger points and acupuncture points.

Therefore, the present invention—immensely magnifying the scale of said preferred embodiments, processes and settings, therefore, provides millions of individuals or patients each and every day—and physicians—who have access to and then use and manipulate the digital contents in their health, health-care and medical records with said means and method for procuring and manipulating said digital information. Said patients can choose words, terms, phrases, sentences, illustrations, images, depictions and/or any combination thereof by pointing by the pointers or the like on the screens and selecting by clicking the computer mice or the like words, terms, phrases, sentences or any combination thereof in their health, health-care and medical records and data. These significant words, terms, phrases, sentences or any combination thereof are enabled to procure or retrieve digital information relating to words, terms, phrases and sentences available from and store in databases comprising health, health-care, medical, surgical scientific data in the computers and/or servers to achieve the objectives of the present invention.

There are many computer programs, software, computer and programming languages, methods and processes commonly known to computer programmers and readily available from many software companies and corporations, such as, but not limited to, Microsoft Corporation, Oracle Corporation, Sybase, Inc. and MySQL, Inc. which can be used to effect supra to achieve the objectives of the present invention.

It is to be understood that said terms also encompass abbreviations, codes, acronyms and the like use in health, health-care, medicine and surgery.

It is to be understood that descriptions supra relate and pertain to about 80 medical and surgical practices, fields or specialties, medicine health-care and all basic health sciences such as, but not limited to, family medicine, sports medicine, neurology, physiatry, gynecology, internal medicine, rheumatology, dermatology, surgeries, endocrinology, genetics, obstetrics, pain medicine, orthopaedics, psychiatry, anatomy, physiology, neurology, pathology, histology, neurophysiology, biomechanics, pathophysiology, microbiology, virology, parasitology and immunology.

Although the system of underlining said words, terms, phrases, sentences, illustrations, images, depictions and the like is used in said preferred embodiments, it is to be understood that any and all other systems of highlighting, noting, remarking, pointing out, such as, but not limited to, bold, colors, color highlights, italics, flash of said words, terms, phrases, sentences, illustrations, images, depictions and the like for physicians and patients will be used as a means for achieving the objectives of the present invention.

Although the preferred embodiments of this invention have been described, it will be appreciated by those skilled in the art and science that adaptations and variations may be made without departing from the spirit and the scope of the claims of the present invention.

1. A method of procuring digital information comprising descriptions of diagnoses, symptoms, signs, aggregates of symptoms and signs, syndromes, diseases, illnesses and disease and illness processes and medications wherein words, terms, phrases and sentences describing diagnoses, symptoms, signs, aggregates of symptoms and signs, syndromes, diseases, illnesses and disease and illness processes and medications in the digital health, health-care and medical records of individuals display by a means for displaying said digital information, heath and medical records are used by said individuals for procuring said digital information, illustrations, images and depictions and related or associated words, terms, phrases and sentences adaptable to be displayed for viewing by said means for displaying said digital information, heath and medical records comprises:
a means for relating a word to digital information in database or databases;
a means for relating a term to digital information in database or databases;
a means for relating a phrase to digital information in database or databases;
a means for relating a sentence to digital information in database or databases;
a means for relating words to digital information in database or databases;
a means for relating terms to digital information in database or databases;
a means for relating phrases to digital information in database or databases;
a means for relating words, terms, phrases to digital information in database or databases;
a process of relating a word to digital information in database or databases;
a process of relating a term to digital information in database or databases;
a process of relating a phrase to digital information in database or databases;
a process of relating a sentence to digital information in database or databases;
a process of relating words to digital information in database or databases;
a process of relating terms to digital information in database or databases;
a process of relating phrases to digital information in database or databases;
a process of relating words, terms, phrases to digital information in database or databases;
a means for enabling a word to procure digital information relating to said word;
a means for enabling a term to procure digital information relating to said term;
a means for enabling a phrase to procure digital information relating to said phrase;
a means for enabling a sentence to procure digital information relating to said sentence;
a means for enabling words to procure digital information relating to said words;
a means for enabling terms to procure digital information relating to said terms;
a means for enabling phrases to procure digital information relating to said phrases;
a means for enabling words, terms, phrases to procure digital information relating to or associating with said words, terms and phrases;
a process of enabling a word to procure digital information relating to said word;
a process of enabling a term to procure digital information relating to said term;
a process of enabling a phrase to procure digital information relating to said phrase;
a process of enabling a sentence to procure digital information relating to said sentence;
a process of enabling words to procure digital information relating to said words;
a process of enabling terms to procure digital information relating to said terms;
a process of enabling phrases to procure digital information relating to said phrases; and
a process of enabling words, terms, phrases to procure digital information relating to or associating with said words, terms and phrases.

2. A method of linking words, terms, phrases, sentences describing diagnoses, symptoms, signs, aggregates of symptoms and signs, syndromes, diseases, illnesses and disease and illness processes and medications in the digital health, health-care and medical records of individuals display by a means for displaying said health, health-care and medical records wherein said words, terms, phrases and sentences are used by individuals and computers or servers to find and procure digital information comprising explanations, information, details, explanations, illustrations, images and depictions on or relate to said diagnoses, symptoms, signs, aggregates of symptoms and signs, syndromes, diseases, illnesses and disease and illness processes and medications adaptable to be displayed by said means for displaying said health, health-care and medical records comprises:
a means for relating a word to digital information in database or databases;
a means for relating a term to digital information in database or databases;
a means for relating a phrase to digital information in database or databases;
a means for relating a sentence to digital information in database or databases;
a means for relating words to digital information in database or databases;
a means for relating terms to digital information in database or databases;
a means for relating phrases to digital information in database or databases;
a means for relating words, terms, phrases to digital information in database or databases;
a process of relating a word to digital information in database or databases;
a process of relating a term to digital information in database or databases;
a process of relating a phrase to digital information in database or databases;
a process of relating a sentence to digital information in database or databases;
a process of relating words to digital information in database or databases;
a process of relating terms to digital information in database or databases;
a process of relating phrases to digital information in database or databases;
a process of relating words, terms, phrases to digital information in database or databases;
a means for enabling a word to procure digital information relating to said word;
a means for enabling a term to procure digital information relating to said term;
a means for enabling a phrase to procure digital information relating to said phrase;
a means for enabling a sentence to procure digital information relating to said sentence;
a means for enabling words to procure digital information relating to said words;
a means for enabling terms to procure digital information relating to said terms;
a means for enabling phrases to procure digital information relating to said phrases;
a means for enabling words, terms, phrases to procure digital information relating to or associating with said words, terms and phrases;
a process of enabling a word to procure digital information relating to said word;
a process of enabling a term to procure digital information relating to said term;
a process of enabling a phrase to procure digital information relating to said phrase;
a process of enabling a sentence to procure digital information relating to said sentence;
a process of enabling words to procure digital information relating to said words;
a process of enabling terms to procure digital information relating to said terms;
a process of enabling phrases to procure digital information relating to said phrases; and
a process of enabling words, terms, phrases to procure digital information relating to or associating with said words, terms and phrases.

3. A method of linking words, terms, phrases and sentences describing diagnoses, symptoms, signs, aggregates of symptoms and signs, syndromes, diseases, illnesses, disease and illness processes, medications in the digital health, health-care and medical records of individuals display by a means for displaying said health, health-care and medical records to digital information comprising explanations, information, details, illustrations, images and depictions on or relate to said diagnoses, symptoms, signs, aggregates of symptoms and signs, syndromes, diseases, illnesses and disease and illness processes and medications and related wherein said words, terms, phrases, sentences are used by individuals and computers or servers to find and procure digital information comprising explanations, information, details, illustrations, images and depictions on or relate to said diagnoses, symptoms, signs, aggregates of symptoms and signs, syndromes, diseases, illnesses and disease and illness processes and medications and related adaptable to be displayed for viewing by said means for displaying and to further procure related, associated or pertinent words, terms, phrases, sentences, descriptions, details, illustrations, images and depictions based on physicians' uses and applications of words, terms, phrases, sentences, images, illustrations and depictions on or relating to diagnoses, symptoms, signs, aggregates of symptoms and signs, syndromes, diseases, illnesses, disease and illness processes and medications adaptable to be displayed and be used by said individuals and wherein words, terms, phrases, sentences, illustrations, images and depictions embedded or present in said descriptions, explanations, information, details, explanations, illustrations, images and depictions further are used and enable said individuals and computers or servers to further procure digital information comprising pertinent or related explanations, details, descriptions, information, details, explanations, illustrations, images and depictions on or relate to said diagnoses, symptoms, signs, aggregates of symptoms and signs, syndromes, diseases, illnesses and disease and illness processes adaptable to be displayed for viewing by said means for displaying comprises:
a means for relating a word to digital information in database or databases;
a means for relating a term to digital information in database or databases;
a means for relating a phrase to digital information in database or databases;
a means for relating a sentence to digital information in database or databases;
a means for relating words to digital information in database or databases;
a means for relating terms to digital information in database or databases;
a means for relating phrases to digital information in database or databases;
a means for relating words, terms, phrases to digital information in database or databases;
a process of relating a word to digital information in database or databases;
a process of relating a term to digital information in database or databases;
a process of relating a phrase to digital information in database or databases;
a process of relating a sentence to digital information in database or databases;
a process of relating words to digital information in database or databases;
a process of relating terms to digital information in database or databases;
a process of relating phrases to digital information in database or databases;
a process of relating words, terms, phrases to digital information in database or databases;
a means for enabling a word to procure digital information relating to said word;
a means for enabling a term to procure digital information relating to said term;
a means for enabling a phrase to procure digital information relating to said phrase;
a means for enabling a sentence to procure digital information relating to said sentence;
a means for enabling words to procure digital information relating to said words;
a means for enabling terms to procure digital information relating to said terms;
a means for enabling phrases to procure digital information relating to said phrases;
a means for enabling words, terms, phrases to procure digital information relating to or associating with said words, terms and phrases;
a process of enabling a word to procure digital information relating to said word;
a process of enabling a term to procure digital information relating to said term;
a process of enabling a phrase to procure digital information relating to said phrase;
a process of enabling a sentence to procure digital information relating to said sentence;
a process of enabling words to procure digital information relating to said words;
a process of enabling terms to procure digital information relating to said terms;
a process of enabling phrases to procure digital information relating to said phrases; and
a process of enabling words, terms, phrases to procure digital information relating to or associating with said words, terms and phrases.
